(19) United States
(12) Patent Application Publication
(10) Pub. No.: US 2025/0058710 A1
(43) Pub. Date: Feb. 20, 2025

(54) SYSTEM AND METHOD FOR CONTROLLING VIRTUAL ENGINE SOUND OF ELECTRIC VEHICLE

(71) Applicants: HYUNDAI MOTOR COMPANY, Seoul (KR); Kia Corporation, Seoul (KR)

(72) Inventors: Sung Hyun Cho, Hwaseong-si (KR); Joseph D Chang, Hwaseong-si (KR); Soo Han Song, Hwaseong-si (KR); Seong Hwan Cheong, Hwaseong-si (KR); Jiwon Oh, Hwaseong-si (KR)

(73) Assignees: HYUNDAI MOTOR COMPANY, Seoul (KR); Kia Corporation, Seoul (KR)

(21) Appl. No.: 18/785,617

(22) Filed: Jul. 26, 2024

(30) Foreign Application Priority Data
Aug. 14, 2023 (KR) 10-2023-0106062
Jun. 10, 2024 (KR) 10-2024-0075223

(51) Int. Cl. B60Q 5/00

(52) U.S. Cl. CPC B60Q 5/008

(57) ABSTRACT

A method for controlling a virtual engine sound of an electric vehicle, may include steps of, which are performed by a controller, collecting a driving state including the vehicle speed of the electric vehicle and the opening amount of an accelerator pedal, determining a virtual gear position based on the vehicle speed of the electric vehicle and the opening amount of the accelerator pedal, obtaining the virtual engine speed of the electric vehicle based on the vehicle speed and the virtual gear position, and outputting a virtual engine sound corresponding to the virtual engine speed.

### CROSS-REFERENCE TO RELATED APPLICATION

The present application claims priority to Korean Patent Application No. 10-2023-0106062 and No. 10-2024-0075223, filed on Aug. 14, 2023 and Jun. 10, 2024, the entire contents of which is incorporated herein for all purposes by this reference.

### BACKGROUND OF THE PRESENT DISCLOSURE

### Field of the Present Disclosure

The present disclosure relates to an electric vehicle. More particularly, the present disclosure relates to controlling of a virtual engine sound of an electric vehicle.

### Description of Related Art

An electric vehicle is a vehicle driven by a motor, and recently, active research and development on electric vehicles have been conducted.

An electric vehicle is equipped with a reducer configured to reduce the rotation number of the motor, and unlike an internal combustion engine vehicle, does not need a multi-stage transmission. Therefore, the electric vehicle may provide a smooth ride without interruption that occurs in multi-stage shifting but lessens the enjoyment of driving which is caused by the multi-stage shifting.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a method and system for controlling a virtual engine sound of an electric vehicle, configured for heightening the enjoyment of driving by providing the same multi-shift sensation as that provided in an internal combustion engine vehicle.

Another object of the present disclosure is to provide a method and system for controlling a virtual engine sound of an electric vehicle, configured for providing a virtual gear shifting sound corresponding to the shifting sensation in an internal combustion engine vehicle.

The object of the present disclosure is not limited to the foregoing, and other objects not mentioned herein will be clearly understood by those of ordinary skill in the art to which the present disclosure pertains (hereinafter, “those skilled in the art”) based on the description below.

The features of the present disclosure to achieve the object of the present disclosure as described above and to perform the characteristic functions of the present disclosure to be described later are as follows.

According to some forms of the present disclosure, a method for controlling a virtual engine sound of an electric vehicle includes collecting, by a controller, a driving state including the vehicle speed of the electric vehicle and the opening amount of an accelerator pedal, determining, by the controller, a virtual gear position based on the vehicle speed of the electric vehicle and the opening amount of the accelerator pedal, obtaining, by the controller, the virtual engine speed of the electric vehicle based on the vehicle speed and virtual gear position, and outputting, by the controller, a virtual engine sound corresponding to the virtual engine speed.

According to some forms of the present disclosure, a system for controlling a virtual engine sound of an electric vehicle includes a controller programmed to perform collecting a driving state of the electric vehicle, determining a virtual engine speed based on the driving state of the electric vehicle, and outputting a virtual engine sound corresponding to the virtual engine speed.

According to some embodiment of the present disclosure, provided an electric vehicle including said system.

Other aspects and exemplary embodiments of the present disclosure are discussed infra.

It is to be understood that the term “vehicle” or “vehicular” or other similar terms as used herein are inclusive of motor vehicles in general, such as passenger vehicles including sports utility vehicles (SUVs), buses, trucks, various commercial vehicles, watercraft including a variety of boats and ships, aircraft, and the like, and include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example, a vehicle powered by both gasoline and electricity.

The above and other features of the present disclosure are discussed infra.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a diagram of a virtual shift system for an electric vehicle according to an exemplary embodiment of the present disclosure;

FIG. 2 is a flowchart showing a control of a virtual gear shifting sound according to various exemplary embodiments of the present disclosure;

FIG. 3 is a flowchart showing a control of a virtual gear shifting sound according to various exemplary embodiments of the present disclosure;

FIG. 4 shows a profile of a gear shifting sound resulting from controlling of a virtual gear shifting sound according to various exemplary embodiments of the present disclosure;

FIG. 5 shows sound profiles in a non-shift condition and fuel cut condition in the profile of the gear shifting sound resulting from controlling of a virtual gear shifting sound according to various exemplary embodiments of the present disclosure;

FIG. 6 shows a sound profile in a power-on upshift condition in the profile of the gear shifting sound resulting from controlling of a virtual gear shifting sound according to various exemplary embodiments of the present disclosure; and

FIG. 7 shows a sound profile in a power-off downshift condition in the profile of the gear shifting sound resulting from controlling of a virtual gear shifting sound according to various exemplary embodiments of the present disclosure.

It should be understood that the appended drawings are not necessarily to scale, presenting a somewhat simplified representation of various exemplary features illustrative of the basic principles of the present disclosure. The predetermined design features of the present disclosure, including, for example, predetermined dimensions, orientations, locations, and shapes, will be determined in portion by the intended application and usage environment.

In the figures, the reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Descriptions of specific structures or functions presented in the exemplary embodiments of the present disclosure are merely exemplary for explaining the exemplary embodiments according to the concept of the present disclosure, and the exemplary embodiments according to the concept of the present disclosure may be implemented in various forms. Furthermore, the descriptions should not be construed as being limited to the exemplary embodiments described herein, and should be understood to include all modifications, equivalents and substitutes falling within the idea and scope of the present disclosure.

Meanwhile, in an exemplary embodiment of the present disclosure, terms such as “first” and/or “second” may be used to describe various components, but the components are not limited by the terms. These terms are only used to distinguish one component from another. For example, a first component could be termed a second component, and similarly, a second component could be termed a first component, without departing from the scope of exemplary embodiments of the present disclosure.

It will be understood that, when a component is referred to as being “connected to” or “brought into contact with” another component, the component may be directly connected to or brought into contact with the other component, or intervening components may also be present. In contrast, when a component is referred to as being “directly connected to” or “brought into direct contact with” another component, there is no intervening component present. Other terms used to describe relationships between components should be interpreted in a like fashion (e.g., “between” versus “directly between,” “adjacent” versus “directly adjacent,” etc.).

Throughout the specification, like reference numerals indicate like components. The terminology used herein is for illustrating embodiments and is not intended to limit the present disclosure. In the present specification, the singular form includes the plural sense, unless specified otherwise. The terms “comprises” and/or “comprising” used in the present specification mean that the cited component, step, operation, and/or element does not exclude the presence or addition of one or more of other components, steps, operations, and/or elements.

Hereinafter, the present disclosure is described in detail with reference to the accompanying drawings.

According to an exemplary embodiment of the present disclosure, an electric vehicle V includes a motor. The electric vehicle V may be driven by the motor. In one example, the electric vehicle V may be a battery electric vehicle. The electric vehicle V may be driven at least partially by the motor. In one example, the electric vehicle V may be a hybrid electric vehicle.

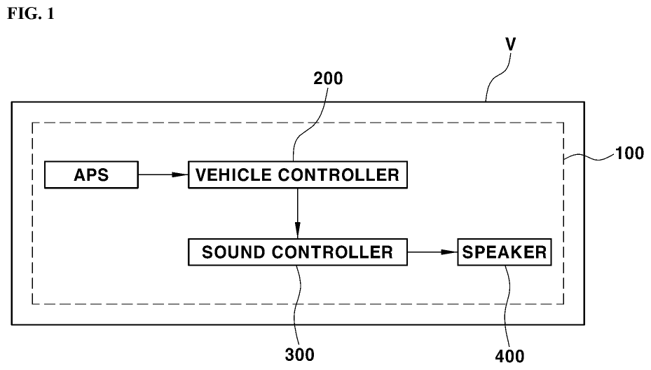

As shown in FIG. 1, according to an exemplary embodiment of the present disclosure, the electric vehicle V includes a virtual shift system 100. The electric vehicle V driven by the motor includes a reducer but may not include the transmission of an internal combustion engine vehicle. However, the virtual shift system 100 may provide the same shifting sensation generated in the internal combustion engine vehicle to the electric vehicle V which does not have an internal combustion engine, adding the enjoyment of driving to the electric vehicle.

The operation of the virtual shift system 100 may be controlled and supervised by a vehicle controller 200. In some examples, one or more separate controllers for the virtual shift system 100 may be provided, and one or more controllers may communicate with the vehicle controller 200. Here, the one or more vehicle controllers 200 means that the operation of the virtual shift system 100 may be performed by one controller or by two or more controllers.

The vehicle controller 200 is configured to communicate with various components of the electric vehicle V. The vehicle controller 200 may collect opening amount (%) information of an accelerator pedal AP of the electric vehicle V. Moreover, the vehicle controller 200 may collect current vehicle speed information of the electric vehicle V in real time.

According to an implementation of the present disclosure, the virtual shift system 100 may be selectively activated. The virtual shift system 100 may be operated by manipulating a button provided in the cabin of the electric vehicle V. For example, a button to activate the virtual shift system 100 may be provided on a cluster, an audio-video-navigation (AVN), etc., of the electric vehicle V. When activation of the virtual shift system 100 is requested using the button, the vehicle controller 200 may activate the virtual shift system 100. Moreover, the electric vehicle V may be provided with a lever that allows an operator to select a gear of P or N, gear D, gear R, etc.

The vehicle controller 200 may perform various calculations.

In an exemplary embodiment of the present disclosure, by activating the virtual shift system 100, the vehicle controller 200 may be configured to determine a current virtual gear position (gear a, a≥0) of the electric vehicle V based on the vehicle speed and the opening amount of the accelerator pedal AP of the electric vehicle V. The vehicle speed of the electric vehicle V may be the average vehicle speed of the left and right driving wheels. The opening amount of the accelerator pedal AP may be detected by an accelerator pedal sensor (APS) of the electric vehicle V.

Moreover, the vehicle controller 200 may be configured to determine the virtual engine speed at a current virtual gear position (gear a) of the electric vehicle V in real time. As shown in Equation 1, the vehicle controller 200 may obtain a virtual engine speed based on the average vehicle speed, tire dynamic radius, and virtual gear ratio of the electric vehicle V.

$${VSE}_{a} = {V}_{avg} \times \frac{1000 \cdot 60 \cdot 2 \cdot π}{{r}_{d}} \times {g}_{a} \qquad [ Equation 1 ]$$

Here, VSEₐ is a virtual engine speed at a virtual gear position (gear a), V_{avg} is an average vehicle speed of the left and right driving wheels of an electric vehicle V, r_{d} is a tire dynamic radius, and gₐ is a virtual gear ratio, which is a value preset depending on the virtual gear position (gear a).

The vehicle controller 200 may obtain a virtual engine angular acceleration based on the opening amount of the accelerator pedal AP.

The vehicle controller 200 may also determine at least one of the sound source or the sound volume of the virtual engine sound depending on the virtual shift state. The vehicle controller 200 may be configured to determine the source and volume of the virtual engine sound based on the virtual engine speed and/or virtual engine angular acceleration at the current virtual gear position. Used herein, the sound source may be a characteristic tone of a virtual engine sound selectable in the vehicle V. As a non-limiting example, the characteristic tone of the virtual engine sound may be a 4-cylinder engine sound, a 6-cylinder engine sound, an 8-cylinder engine sound, etc. The vehicle controller 200 may be configured to determine the source of the virtual engine sound depending on the virtual shifting of the vehicle V. In an exemplary embodiment of the present disclosure, the volume of the virtual engine sound may be the magnitude of the selected sound source (i.e., how big or small the sound is).

In an internal combustion engine vehicle, power from the engine is transmitted to a clutch torque of the transmission and to the wheels through the gear ratio. In other words, an engine torque may be used for driving or partial braking of the vehicle. The engine torque Tₑ representing the present relationship may be modeled as shown in Equation 2.

$${T}_{e} = {T}_{c} + {J}_{e} \cdot a , \qquad [ Equation 2 ]$$

wherein T_{c} is a clutch torque, Je is an engine moving system's inertia, and α is an engine angular acceleration.

Equation 2 shows that the main factors representing the engine sound are the engine torque Tₑ, which is output from the fuel injected into the engine, and the engine angular acceleration α, generated by the engine torque Tₑ. Engine torque Tₑ may be determined from the input of the accelerator pedal operated by a driver. In addition to the accelerator pedal, when the clutch torque T_{c} of the transmission transmits the engine torque Tₑ based on the amount of air drawn in into the engine and the amount of fuel injected into the engine, the engine torque Tₑ may be configured to generate an engine angular acceleration α corresponding thereto.

In other words, the main factors that generate the engine torque Tₑ are the accelerator pedal, air volume, and injected fuel, and the result therefrom is an engine angular acceleration α. Because the virtual shift system 100 is a virtual system, the amount of air and fuel injection in the virtual shift system 100 cannot be known.

Therefore, it may be said that the virtual engine sound is generated in proportion to the magnitude of the virtual engine torque, and ultimately, the virtual engine sound may imitate the engine torque through the input opening amount of the accelerator pedal AP and the virtual engine angular acceleration. As it is already well known that engine sound increases in proportion to the engine speed, the fact that the volume % of the virtual engine sound may be determined based on the opening amount of the accelerator pedal AP, virtual engine speed, and virtual engine angular acceleration may also be known.

The virtual shift system 100 may further include a sound controller 300. The sound controller 300 may be included in the vehicle controller 200 or may be one or more sound controllers provided separately from the vehicle controller 200.

The sound controller 300 may be configured to determine the source of the virtual engine sound and the magnitude of the sound source corresponding to the virtual engine speed at a current virtual gear position obtained from the vehicle controller 200. Based on the determined sound source and magnitude of the sound source, the sound controller 300 may transmit the source of the virtual engine sound and the magnitude of the corresponding sound source.

The sound controller 300 may transmit a sound source of a virtual engine sound including a determined magnitude through an output device including a speaker 400. The speaker 400 may be mounted at least either inside or outside the electric vehicle V.

As is described below, according to an exemplary embodiment of the present disclosure, the virtual engine sound may be controlled to be output differently depending on the virtual gear position that changes in real time.

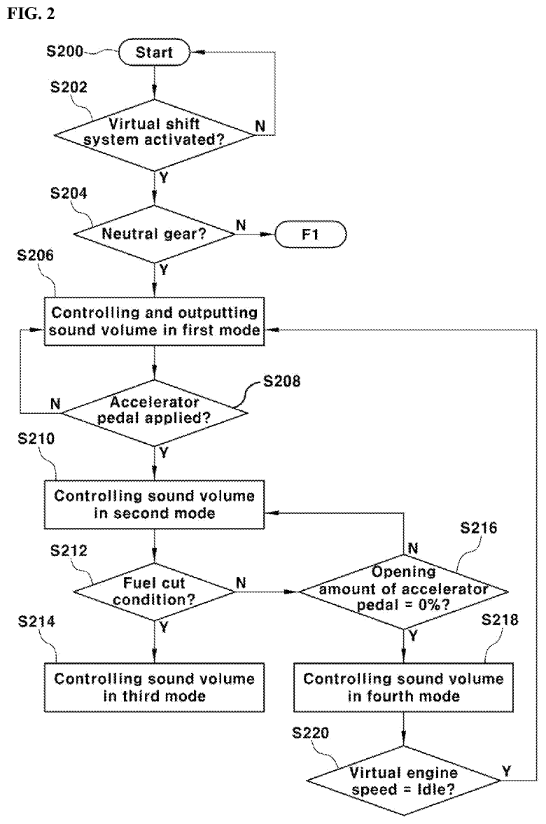

Referring to FIG. 2, a control for generating a virtual engine sound depending on the virtual shift state begins at operation S200.

At operation S202, the vehicle controller 200 is configured to determine whether the virtual shift system 100 is activated. As described above, in one example, the virtual shift system 100 may be activated by a driver of the vehicle V.

At operation S204, the vehicle controller 200 is configured to determine whether the electric vehicle V is currently in neutral gear (N or P). The vehicle controller 200 moves to F1 when the electric vehicle V is currently not in neutral gear or moves to operation S206 when the vehicle is currently in neutral gear.

In neutral gear, the vehicle controller 200 may command the sound controller 300 to control the sound source, which is to be output in a first mode, and the magnitude of the sound source and to output virtual engine sound according thereto. In the first mode, a virtual engine sound corresponding to the virtual engine speed obtained by Equation 3 may be output. The first mode may imitate the engine sound in idling.

$$Virtual engine speed in idling = Reference idle speed + / - First offset \qquad [ Equation 3 ]$$

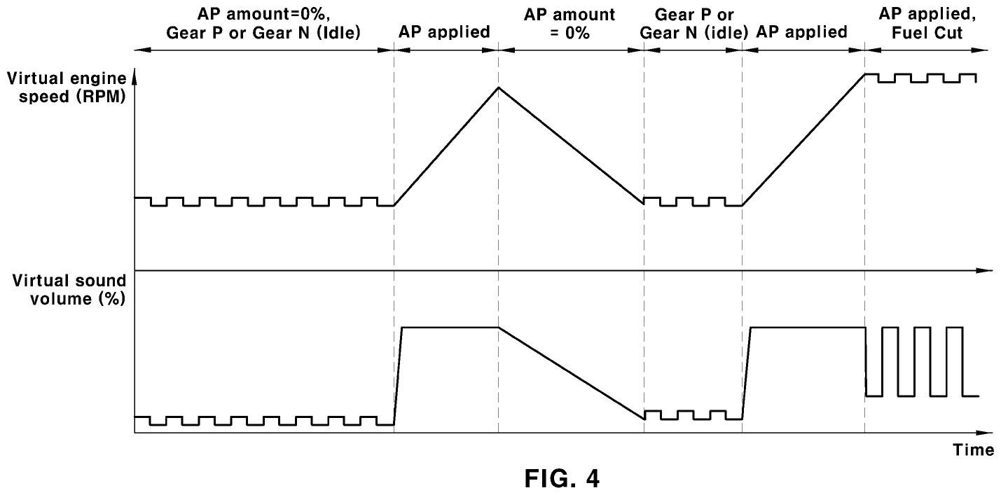

In neutral gear, a (virtual) engine speed maintains an idle state. To imitate the engine idling in an internal combustion engine, reproduced is the phenomenon in which the idle speed is kept constant but slightly fluctuates. As shown in FIG. 4, to imitate the phenomenon, the virtual engine speed may fluctuate with a positive or negative first offset at predetermined intervals with respect to a reference idle speed. To reproduce the fluctuation in the virtual engine speed, the vehicle controller 200 is configured to determine a profile of the virtual engine sound to be output in an idle state and instructs the sound controller 300 to generate a virtual engine sound including the determined profile. The generated virtual engine sound is transmitted by the speaker 400 to audibly express the idling. In the first mode, the virtual engine sound is output depending on the virtual engine speed and increases or decreases in proportion to the magnitude of the virtual engine speed.

In neutral gear, the vehicle controller 200 is configured to determine whether the accelerator pedal AP is applied, at operation S208. When the accelerator pedal AP is not applied, the vehicle controller 200 is configured to control and outputs the virtual engine sound in the first mode, at operation S206.

When the vehicle controller 200 detects that the accelerator pedal AP is applied, the vehicle controller 200 allows the virtual engine sound to be controlled in a second mode at operation S210. In the second mode, a sound imitating the in-gear state may be provided. The virtual engine speed increases at a slope set depending on the opening amount of the accelerator pedal AP as shown in Equation 4. In the second mode, a virtual engine sound set depending on the opening amount of the accelerator pedal AP and the virtual engine speed as the virtual engine speed increases or decreases may be output.

$$Virtual engine speed ( t ) @ Accelerator pedal applied = Virtual engine speed ( t - 1 ) + Engine speed slope ( set value depending on accelerator pedal ) \qquad [ Equation 4 ]$$

Here, t is current time and t−1 is before current time.

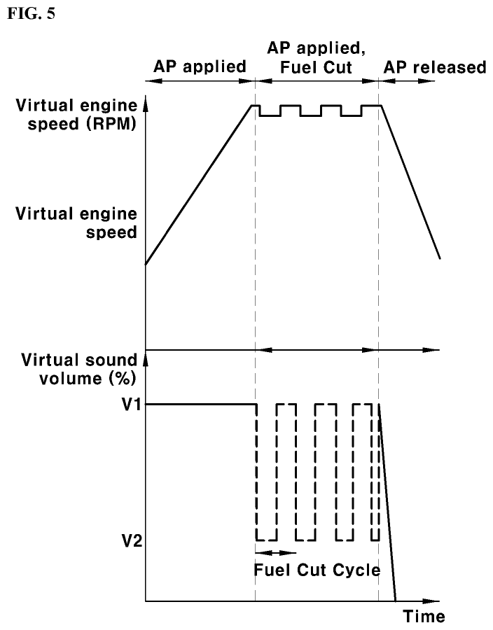

Additionally referring to FIG. 5, at operation S212, the vehicle controller 200 is configured to determine whether the electric vehicle V is currently in fuel cut condition. When the vehicle is determined to be in fuel cut condition, the vehicle controller 200 may be configured for controlling a virtual engine sound in a third mode where a virtual engine sound imitating the fuel cut condition is generated, at operation S214.

In a condition where the virtual engine speed increases as shown in Equation 4, when a predetermined engine red-zone start speed is reached, the virtual engine speed functions as shown in Equation 5. An engine red-zone or the redline of an engine is indicated in a speedometer of a vehicle, and the engine red-zone start speed is predetermined during manufacturing. The engine red-zone start speed is designed to protect an engine or a traction motor from over-revving and may be referred to as a safety threshold with respect to revolutions per minute (RPM) of the engine or the motor.

$$Virtual engine speed in fuel cut condition = Virtual engine red - zone start speed + / - second offset \qquad [ Equation 5 ]$$

By the vehicle controller 200, a virtual engine speed in fuel cut condition is determined as in Equation 5 and repeats at predetermined intervals. Here, a virtual engine sound in fuel cut condition also repeats at predetermined intervals, same as in neutral gear. The magnitude of the sound source set depending on the opening amount of the accelerator pedal AP and the virtual engine speed and the magnitude of the sound source imitating the fuel being drained from an engine are specified to control the slope of the magnitude of the sound source, which is repeatedly increased or decreased at predetermined intervals, to thereby output sound. The fluctuation is indicated as a second offset in Equation 5, and the second offset may be greater than the first offset in neutral gear.

When the vehicle controller 200 determines that the vehicle is not in fuel cut condition at operation S212, the vehicle controller 200 is configured to determine whether the opening amount of the accelerator pedal AP is 0% (accelerator pedal not applied) at operation S216. When the opening amount of the accelerator pedal AP is not 0%, the vehicle controller 200 returns to operation S210. Conversely, when the opening amount of the accelerator pedal AP is 0%, the vehicle controller 200 is configured to control the virtual engine sound in a fourth mode, at operation S218.

When the opening of the accelerator pedal AP is fully open (0%), the virtual engine speed decreases as shown in Equation 6. In the fourth mode, a virtual engine sound set depending on the opening amount of the accelerator pedal AP and the virtual engine speed is output.

$$Virtual engine speed ( Accelerator pedal not applied ) ( t ) = Virtual engine speed ( t - 1 ) + Engine speed slope ( Value set depending on virtual engine speed ) \qquad [ Equation 6 ]$$

At operation S220, the vehicle controller 200 is configured to determine whether the virtual engine speed is in an idle state. When the virtual engine speed reaches a reference idle speed set in an idle state, the virtual engine speed is determined as shown in Equation 3, and the vehicle controller 200 returns to operation S206 so that the virtual engine sound is output when the engine is idling as described above.

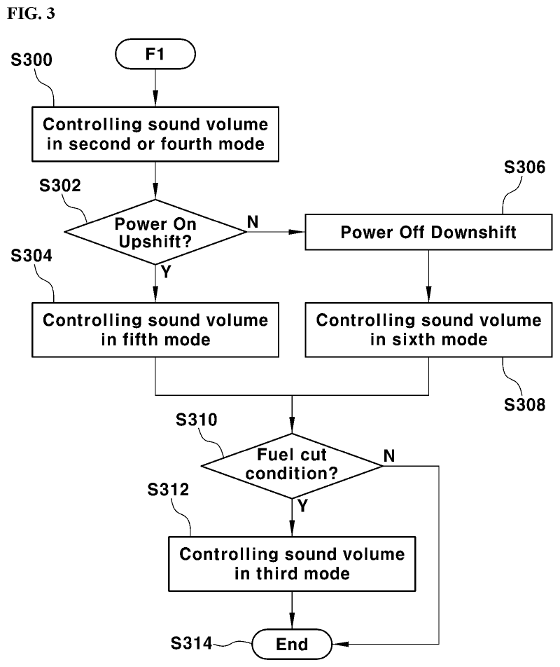

Referring to FIG. 3, in F1, when the controller concludes that the electric vehicle V is currently not in neutral gear, the vehicle is determined to be in in-gear state and the virtual engine sound to be outputted by the vehicle controller 200 may be controlled in the second mode or in the fourth mode, at operation S300. As described above, because the virtual engine speed increases at a set slope depending on the opening amount of the accelerator pedal AP in the second mode, the opening amount of the accelerator pedal AP and the virtual engine sound set depending on the virtual engine speed may be output. In the fourth mode, the opening amount of the accelerator pedal AP is 0%, and the virtual engine speed decreases at a set slope. Accordingly, in the fourth mode, the opening amount of the accelerator pedal AP and the virtual engine sound set depending on the virtual engine speed may be output.

As described above, in a non-shift (in-gear) gear α, the virtual engine speed (VSE_{in-gear,a}) may be determined as shown in Equation 7.

$${VSE}_{i n - gear , a} = {V}_{avg} \times \frac{1000 \cdot 60 \cdot 2 \cdot π}{{r}_{d}} \times {g}_{i n - gear , a} \qquad [ Equation 7 ]$$

The virtual engine sound is output depending on the determined virtual engine speed and the opening amount of the accelerator pedal AP. To prevent rapid changes in sound volume during the present time, the vehicle controller 200 adjusts the sound volume with a positive or negative slope determined depending on the opening amount of the accelerator pedal AP and the value of the virtual engine speed through slope control.

From operation S302 and afterwards, outputting of the virtual engine sound in shift may be controlled.

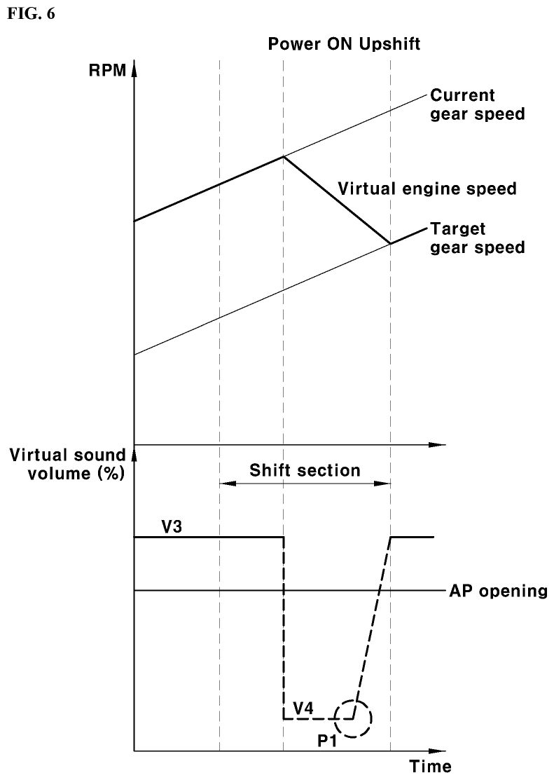

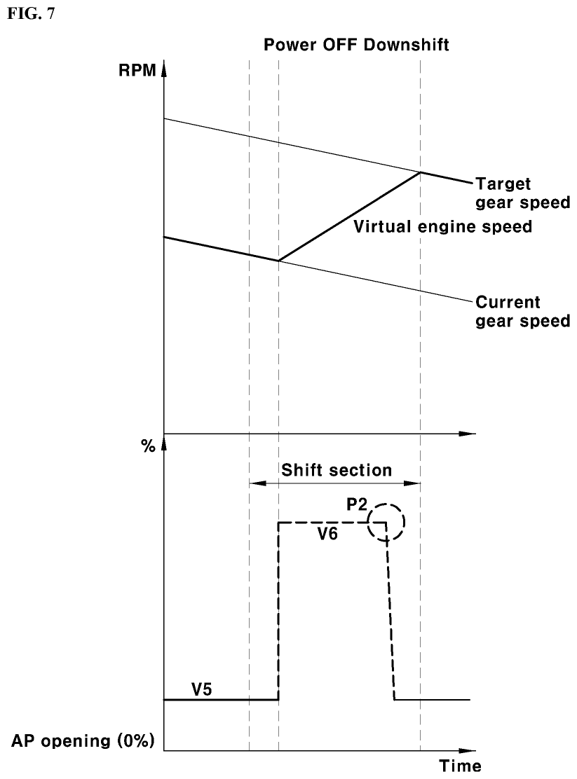

Referring to FIGS. 6 to 7, at operations S302 and S306, the vehicle controller 200 is configured to determine whether a power-on upshift or a power-off downshift occurs. “Power-on upshift” means “upshift” when the accelerator pedal AP is applied. In an internal combustion engine vehicle, when a power-on upshift occurs, a transmission controller is configured for transmitting a request to reduce an engine torque. As an engine controller responds to the request, the slope of the engine angular acceleration is determined to be negative.

“Downshift,” with the accelerator pedal AP not being applied, is referred to as “power-off downshift.” In an internal combustion engine vehicle, when a power-off downshift occurs, a transmission controller is configured for transmitting a request to increase the engine torque and an engine controller responds to the request, determining the slope of the engine angular acceleration to be positive.

Similarly, the virtual shift system 100 may be configured to generate an engine sound by imitating the changing process of the engine torque in the power-on upshift and power-off downshift conditions. When the power-on upshift occurs, the vehicle controller 200 is configured to control the virtual engine sound in a fifth mode at operation S304. When the power-off downshift occurs, the vehicle controller 200 is configured to control the virtual engine sound in a sixth mode, at operation S308.

In the fifth and sixth modes, the vehicle controller 200 may be configured to determine the slope of the virtual engine sound to be negative or positive based on a shift progress rate and the virtual engine angular acceleration.

The shift progress rate % depends on the difference between a total time tₜ and a remaining time tᵣₑₘ. The total time tₜ is a time taken for the virtual engine speed to change from the current gear speed to the target gear speed in the power-on upshift or power-off downshift. The remaining time tᵣₑₘ is a time that remains from the current time point until reaching the target gear speed. The shift progress rate may be determined by Equation 8.

$$Shift progress rate ( \% ) = \frac{( {t}_{tot} - {t}_{rem} )}{{t}_{tot}} \times 100 \qquad [ Equation 8 ]$$

The virtual engine speed at a virtual gear position (gear a) that changes in real time is determined using Equation 1. Similarly, the target shift speed at a virtual gear position (a+x) may be determined using Equation 9. Here, a+x is a target shift gear. tᵣₑₘ may be obtained by dividing a virtual engine slip speed by the virtual engine angular acceleration. The virtual engine slip speed is the difference between the virtual engine speed that changes with time during shifting and the virtual engine speed at the virtual target gear position (a+x). The virtual engine speed at the virtual target gear position (a+x) may be obtained using Equation 9, similar to Equation 1.

$${VSE}_{a + x} = {V}_{avg} \times \frac{1000 \cdot 60 \cdot 2 \cdot π}{{r}_{d}} \times {g}_{a + x} \qquad [ Equation 9 ]$$

Here, VSEₐ₊ₓ is a virtual engine speed at a virtual target gear position (gear a+x), V_{avg} is an average vehicle speed of the left and right driving wheels of an electric vehicle V, r_{d} is a tire dynamic radius, and gₐ₊ₓ is a virtual gear ratio, which is a value preset depending on the virtual target gear position (a+x).

The shift progress rate is a variable that changes depending on a difference in RPM from the current gear position to the final target of the shifting determined using the vehicle speed when shifting, securing a consistent profile for each shift timing in various shift cases in which the shift pattern changes depending on the vehicle speed. Moreover, the engine angular acceleration indicates the speed of transition from the current gear to the target gear depending on the vehicle speed. The speed generally depends on the drive mode (Eco/Normal/Sport/Sport+, etc.), so that the closer the engine speed slope is to Sports+, the faster it becomes. In an internal combustion engine, the magnitude of a cooperative control called “intervention” is adjusted to control the speed. For the present reason, allowing the sound to be adjusted depending on the speed, i.e., the shift progress rate, ultimately serves to satisfy the degree of reality imitating the cooperative control between the engine and transmission.

At operation S310, when the shifting from the current gear to the target gear is completed, the vehicle controller 200 is configured to determine whether the vehicle is in fuel cut condition. When determined that the vehicle is not in fuel cut condition, the controlling ends at operation S314. When the vehicle is determined to be in fuel cut condition, similar to operations S212 and S214, the vehicle controller 200 outputs a virtual engine sound corresponding to the third mode, at operation S312.

According to an exemplary embodiment of the present disclosure, the shift mechanism in an actual internal combustion engine is analyzed to improve the quality of the virtual engine sound so that the actual engine sound of the internal combustion engine may be reproduced in the virtual shift system, heightening the enjoyment of driving.

As is apparent from the above description, the present disclosure provides the following effects.

According to an exemplary embodiment of the present disclosure, provided is a method and system for controlling a virtual engine sound of an electric vehicle, configured for heightening the enjoyment of driving by providing the same multi-shift sensation as that provided in an internal combustion engine vehicle.

According to an exemplary embodiment of the present disclosure, provided is a method and system for controlling a virtual engine sound of an electric vehicle, configured for providing a virtual gear shifting sound corresponding to the shifting sensation in an internal combustion engine vehicle.

Effects of the present disclosure are not limited to what has been described above, and other effects not mentioned herein will be clearly recognized by those skilled in the art based on the above description.

Furthermore, the term related to a control device such as “controller”, “control apparatus”, “control unit”, “control device”, “control module”, “control circuit”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may be configured for processing data according to a program provided from the memory, and may be configured to generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by a plurality of control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

Hereinafter, the fact that pieces of hardware are coupled operably may include the fact that a direct and/or indirect connection between the pieces of hardware is established by wired and/or wirelessly.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A method for controlling a virtual engine sound of an electric vehicle, the method comprising:
collecting, by a controller, a driving state of the electric vehicle, including a vehicle speed and an opening amount of an accelerator pedal;
determining, by the controller, a virtual gear position based on the vehicle speed and the opening amount of the accelerator pedal;
determining, by the controller, a virtual engine speed of the electric vehicle based on the vehicle speed and the virtual gear position; and
outputting, by the controller, a virtual engine sound corresponding to the virtual engine speed through an output device.

2. The method of claim 1, wherein the outputting of the virtual engine sound through the output device includes:
determining a sound source and a sound volume corresponding to the virtual engine speed; and
outputting the sound source at a determined sound volume.

3. The method of claim 1, further including:
in response to an application of the accelerator pedal of the electric vehicle,
outputting, by the controller, the virtual engine sound including a sound source and a sound volume determined based on the virtual engine speed and the opening amount of the accelerator pedal.

4. The method of claim 3, including:
determining, by the controller, whether the driving state is in a fuel cut condition;
in response to the determining that the driving state is in the fuel cut condition, determining, by the controller, a sound source and a sound volume corresponding to the virtual engine speed in the fuel cut condition; and
adjusting, by the controller, a volume of the sound source to a predetermined volume at predetermined time intervals.

5. The method of claim 1, including:
determining, by the controller, whether a power-on upshift occurs; and
in response to the power-on upshift, determining, by the controller, the virtual engine sound to be outputted based on a shift progress rate and a virtual engine angular acceleration in the power-on upshift.

6. The method of claim 1, including:
determining, by the controller, whether a power-off downshift occurs; and
in response to the determining that the power-off downshift occurs, determining, by the controller, the virtual engine sound to be outputted based on a shift progress rate and a virtual engine angular acceleration in the power-off downshift.

7. The method of claim 6, wherein the shift progress rate is determined based on a difference between a total time that takes for the virtual engine speed to change from a current gear speed to a target gear speed and a remaining time from a current time point until reaching the target gear speed.

8. The method of claim 1, including:
in response to concluding that the driving state is in a neutral gear,
determining, by the controller, a sound source and a sound volume corresponding to the virtual engine speed at the neutral gear; and
adjusting, by the controller, a volume of the sound source to a predetermined first volume at predetermined time intervals.

9. The method of claim 3, including:
determining, by the controller, whether the driving state is in a fuel cut condition;
in response to the determining that the driving state is in the fuel cut condition, determining, by the controller, a sound source and a sound volume corresponding to the virtual engine speed in the fuel cut condition; and
adjusting, by the controller, a volume of the sound source to a predetermined second volume at predetermined time intervals, wherein the second volume is greater than a first volume.

10. A system for controlling a virtual engine sound of an electric vehicle, the system comprising:
a processor; and
a non-transitory storage medium containing program instructions,
wherein the processor is configured to, by executing the program instructions:
collect a driving state of the electric vehicle, the driving state including a vehicle speed and an opening amount of an accelerator pedal;
determine a virtual gear position based on the vehicle speed and the opening amount of the accelerator pedal;
determine a virtual engine speed of the electric vehicle based on the vehicle speed and the virtual gear position; and
output a virtual engine sound corresponding to the virtual engine speed through an output device.

11. The system of claim 10, wherein in the outputting of the virtual engine sound through the output device, the processor is further configured to:
determine a sound source and a sound volume corresponding to the virtual engine speed; and
output the sound source at a determined sound volume.

12. The system of claim 10, wherein the processor is further configured to:
in response to an application of the accelerator pedal of the electric vehicle,
output the virtual engine sound including a sound source and a sound volume determined based on the virtual engine speed and the opening amount of the accelerator pedal.

13. The system of claim 12, wherein the processor is further configured to:
determine whether the driving state is in a fuel cut condition;
in response to the determining that the driving state is in the fuel cut condition, determine a sound source and a sound volume corresponding to the virtual engine speed in the fuel cut condition; and
adjust a volume of the sound source to a predetermined volume at predetermined time intervals.

14. The system of claim 10, wherein the processor is further configured to:
determine whether a power-on upshift occurs; and
in response to the determining that the power-on upshift occurs, determine the virtual engine sound to be outputted based on a shift progress rate and a virtual engine angular acceleration in the power-on upshift.

15. The system of claim 10, wherein the processor is further configured to:
determine whether a power-off downshift occurs; and
in response to the determining that the power-off downshift occurs, determine the virtual engine sound to be outputted based on a shift progress rate and a virtual engine angular acceleration in the power-off downshift.

16. The system of claim 15, wherein the shift progress rate is determined based on a difference between a total time that takes for the virtual engine speed to change from a current gear speed to a target gear speed and a remaining time from a current time point until reaching the target gear speed.

17. The system of claim 10, wherein the processor is further configured to:
in response to concluding that the driving state is in a neutral gear,
determine a sound source and a sound volume corresponding to the virtual engine speed at the neutral gear; and
adjust a volume of the sound source to a predetermined first volume at predetermined time intervals.

18. The system of claim 12, wherein the processor is further configured to:
determine whether the driving state is in a fuel cut condition;
in response to the determining that the driving state is in the fuel cut condition, determine a sound source and a sound volume corresponding to the virtual engine speed in the fuel cut condition; and
adjust a volume of the sound source to a predetermined second volume at predetermined time intervals, wherein the second volume is greater than a first volume.

19. The electric vehicle comprising the system of claim 10.
